(19) United States
(12) Patent Application Publication
(10) Pub. No.: US 2005/0010861 A1
(43) Pub. Date: Jan. 13, 2005

(54) System and method for updating data on a remote display

(75) Inventors: William J. Augustyn, Hartland, WI (US); Kenneth M. Boltz, Delafield, WI (US)

Correspondence Address: FOLEY & LARDNER, 777 EAST WISCONSIN AVENUE, SUITE 3800, MILWAUKEE, WI, 53202-5308, US

(73) Assignee: Adaptive Micro Systems LLC

(21) Appl. No.: 10/845,728

(22) Filed: May 14, 2004

Related U.S. Application Data
(60) Provisional application No. 60/470,313, filed on May 14, 2003.

(51) Int. Cl. G06F 15/00

(52) U.S. Cl. 715/503

(57) ABSTRACT

A system for synchronizing data in a spreadsheet application with data on a remote display is described. The system includes at least one data cell in the spreadsheet application. The data cell contains data to be displayed on the remote display and at least one characteristic associated with the data. The system further includes an add-on function associated with the spreadsheet configured to detect changes to the data or the at least one characteristic, and to transmit a message to update the remote display based on detection of a change in the data or the at least one characteristic.

### CROSS REFERENCE TO RELATED APPLICATIONS

The present Application claims the benefit of priority, as available under 35 U.S.C. § 119(e)(1), to U.S. Provisional Patent Application No. 60/470,313 titled “System and Method for Updating Data on a Remote Display” filed on May 14, 2003 (which is incorporated by reference in its entirety).

### BACKGROUND OF THE INVENTION

The present invention relates generally to the field of display control systems. More particularly, the present invention relates to a system and method for automatically updating information displayed on a remote display from at least one cell in a spreadsheet.

LED message displays are large displays that can be used to display data both indoors and outdoors. Applications for the displays can include displaying transportation information, retail advertising information, gaming and lottery information, productivity information, etc. The applications include any use where it is desirable to have a large display to communicate information to viewers from a variety of distances.

The information that is displayed on the LED message displays can be uploaded to the display from a computer. The computer is coupled to the display either directly or indirectly. An example of an direct connection can include a serial cable connected to a COM port on the computer and an input port for the display. An example of an indirect connection can include a connection through a network between a computer connected to the network and a display connected to the network.

The information stored on the computer to be displayed on the display is uploaded to the display based on a series of commands entered by a computer user. The commands typically involve complicated network protocol information, formatting information, display protocol information, etc. Additionally, the data is not uploaded automatically from the computer to the display such that changes in the data on the computer are automatically updated on the display.

Users have been able to write programs that are used to change information on the display. However, an advanced knowledge of computer programming is required to write such a program. Further, these computer programs are generally not automated and may not be understandable to an average user.

What is needed is a computer application that is configured to store data for display on a remote display where changes to the data will automatically be updated on the display. What is further needed is an application that is configured to also recognize changes to at least one characteristic of the data associated with the display and automatically update those characteristics on the display.

### SUMMARY OF THE INVENTION

One embodiment of the invention relates to a system for synchronizing data in a spreadsheet application with data on a remote display. The system includes at least one data cell in the spreadsheet application. The data cell contains data to be displayed on the remote display and at least one characteristic associated with the data. The system further includes an add-on function associated with the spreadsheet configured to detect changes to the data or the at least one characteristic, and to transmit a message to update the remote display based on detection of a change in the data or the at least one characteristic.

A second embodiment of the invention relates to a method for synchronizing the content of cells in a spreadsheet with a remote display displaying the content of the cells. The method includes detecting a change in the contents of a cell in the spreadsheet, determining the content of the cell that was changed, determining at least one characteristic for the cell that was changed, and transmitting a message to the remote display to update the display based on the detected change.

A third embodiment of the invention relates to a system for displaying information on a remote display. The system includes a remote display configured to display information, a data connection configured to transmit information to the remote display, and a computer including a spreadsheet application. The spreadsheet application includes an add-on function configured to detect changes to the contents of a spreadsheet. The computer is configured to transmit data to the remote display based on the detection of changes to the contents of a spreadsheet.

Other principle features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals denote like elements, and:

FIG. 1 is a remote display for displaying information stored in a spreadsheet according to an exemplary embodiment;

FIG. 2 is a computing system including a spreadsheet application for updating information to be displayed on a remote display according to an exemplary embodiment;

FIG. 3 is the computing system of FIG. 2 in a networked environment in communication with the display of FIG. 1;

FIG. 4 is a flow diagram illustrating a method for synchronizing the content of cells in a spreadsheet with a remote display displaying the content of the cells;

FIG. 5 is a spreadsheet application including a drop down menu implementing an add-on function according to an exemplary embodiment; and

FIG. 6 is a display area displaying data from the spreadsheet application of FIG. 5 according to an exemplary embodiment.

### DETAILED DESCRIPTION OF THE PREFERRED EMBODIMENTS

A system and method for updating information displayed on a remote display is described. In the following description, for purposes of explanation, numerous specific details are set forth in order to provide a thorough understanding of the present invention. It will be evident, however, to one skilled in the art that the exemplary embodiments may be practiced without these specific details. In other instances, structures and devices are shown in block diagram form in order to facilitate description of the exemplary embodiments.

In one embodiment, a computer system is used which has a central processing unit (CPU) that executes sequences of instructions contained in a memory. More specifically, execution of the sequences of instructions causes the CPU to perform steps, which are described below. The instructions may be loaded into a random access memory (RAM) for execution by the CPU from a read-only memory (ROM), a mass storage device, or some other persistent storage. In other embodiments, hardwired circuitry may be used in place of, or in combination with, software instructions to implement the functions described. Thus, the embodiments described herein are not limited to any specific combination of hardware circuitry and software, nor to any particular source for the instructions executed by the computer system.

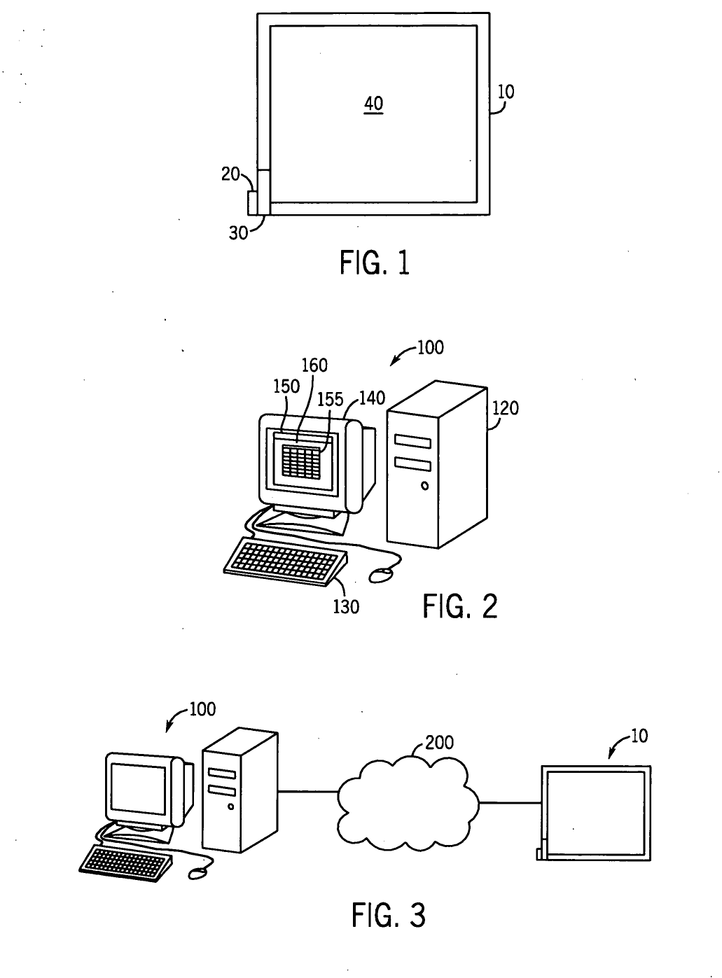

FIG. 1 illustrates a display 10 according to an exemplary embodiment. Display 10 is any type of display, For example, display 10 can be a light emitting diode (LED) display, such as the AlphaEclipse 3500 Series displays manufactured by Adaptive Micro Systems, Inc. of Milwaukee, Wis. Display 10 includes an input port 20, a processor 30, and a display area 40. Input port 20 can be any type of input port configured to receive display data from an external source for display on display 10. The display data received at input port 20 can include a display message and at least one characteristic associated with the display message. A display message can include text, images, numbers, or any other content to be displayed. Processor 30 can be any type of processor configured to receive the display data from input port 20 and actuate display area 40 to display the display message. Display area 40 can be any type of display configured to display a display message.

In operation, display data is received through input port 20 by processor 30. Processor 30 is configured to process the display data to determine the display message to be displayed in display area 40 as well as any characteristics associated with the display message. Exemplary display characteristics can include the size of the display message, justification of the display message within the display, color of the display message, etc. The display message can be displayed within display area 40 when display data is processed by processor 30.

Display 10 can be used for any purpose where it is desirable to communicate information to a number of people from a variety of distances. Examples can include display of productivity information to a manufacturing plant floor, game information in a sports arena, retail information to passing motorists, etc.

Advantageously, a display message that is being displayed on display 10 may be easily updated. Updated information can be communicated to display 10 from a data source through input port 20. According to an exemplary embodiment, new or updated information can be continuously provide through input port 20 where the data source is connected to input port 20.

FIG. 2 illustrates a display message origination system 100 for maintaining and communicating display data to a remote display according to an exemplary embodiment. Display message origination system 100 can be any type of computing device, including work stations, laptops, notebooks, personal digital assistants (PDAs), cell phones, or other equipment. Generally, display message origination system 100 can be implemented using a computer server configured by software. Preferably, the server includes read/write memory, such as, disk drives and other storage.

Display message origination system 100 includes a processor 120, an input device 130, and a display 140. Processor 120 can be any type of processor configured to perform operations on the display data. Input device 130 can include any type of device for receiving input from a user of the display message origination system 100, such as a keyboard, a scanner, a microphone, etc. Display 140 can be any type of output device for communicating information to the a user of display message origination system 100, such as a cathode ray tube (CRT) display, a liquid crystal display (LCD), etc.

Display message origination system 100 can be configured to utilize a spreadsheet application 150. Spreadsheet application 150 can be any type of spreadsheet application such as the Microsoft® Excel™ spreadsheet application, produced by Microsoft® Corporation of Redmond, Wash.

According to an exemplary embodiment, spreadsheet application 150 can be configured to store and maintain a display spreadsheet 155. Display spreadsheet 155 can be a spreadsheet that is stored and maintained using display message origination system 100 and spreadsheet application 150.

Spreadsheet 155 includes a table 160 containing display data to be display on display 10. The table of data is composed of a plurality of cells grouped in rows and columns. According to alternative embodiments, table 160 can include as many cells as needed, including a table including only one cell. Each of the plurality of cells contains a display message to be displayed on display 10. The display message to be displayed can include text data, numerical data, or any other data type. Each cell further includes at least one characteristic associated with the data stored in the cell. The at least one characteristic can include a font, a justification, a color, or any other characteristic.

In operation, table 160 can be populated with information to be displayed on display 10. The information can be received from a user using input device 130. The user can select a specific cell in table 160 and enter a display message using input device 130. The cell may have default characteristics that will be associated with the display message. The default characteristics can be modified by the user as desired.

According to an alternative embodiment, the contents of a cell in table 160 can be populated from an external source. The external source can be a source associated with display message origination system 100, such as a computer program operating on display message origination system 100. The computer program can generate a display message and communicate that display message to spreadsheet application 150 for entry into the cell. An example can include a timekeeping computer program that is generating a current time display message. The current time display message can be communicated to spreadsheet application 150 for entry into the cell. According to yet another exemplary embodiment, the external source can be a source that is not associated with display message origination system 100, but is in communication with display message origination system 100 such as a data source that communicates with display message origination system 100 through a network connection. An example can include a data source for a current stock price. The stock price can be communicated to display message origination system 100 through an Internet connection and then communicated to spreadsheet application 150 for entry into the cell.

The display message can be entered directly in a cell within table 160 or further processed prior to entry into a cell. Processing can include any mathematical, logical, or other type of processing to manipulate the display message. Examples can include converting a display message from one format into another, such as converting a Celsius temperature into a Fahrenheit temperature, normalizing the data according to some criteria, calculating an average value, etc. The functions to process the display message can be implemented with spreadsheet application 150 or any other application.

Spreadsheet application 150 can further include a display add-on function. The display add-on function can be any type of application, program, or function that is configured to automatically transfer display data from spreadsheet 155 to display 10 based on detection of a change in the display data for a cell in table 160.

The add-on function can be implemented as a macro or series of macros within spreadsheet application 150, an application running independently of spreadsheet application 150 in communication with spreadsheet application 150, or any other function that is configured to monitor and manipulate data stored in display spreadsheet 155.

According to an exemplary embodiment, the add-on function is implemented as a series of macros designed to operate in conjunction with Microsoft® Excel™ spreadsheets.

Referring to FIG. 3, display 10 is illustrated coupled to display message origination system 100 in a networked environment according to an exemplary embodiment. Display message origination system 100 is configured to communicate with display 10 via network 200. In an exemplary embodiment, network 200 is the Internet, a worldwide network of computer networks that use various protocols to facilitate data transmission and exchange. Network 200 can use a protocol, such as, the TCP/IP network protocol or the DECnet, X.25, and UDP protocols. In alternative embodiments, network 200 is any type of network, such as, a virtual private network (VPN), an Ethernet, or a Netware network. According to yet another exemplary embodiment, network 200 can be a wireless network using for example, satellite, cellular, or RF networks to communicate.

Network 200 can include a configuration, such as, a wide area network (WAN) or a local area network (LAN). The data can be transferred over network 200 using a secure web connection.

In operation, display message origination system 100 can be connected to display 10 through network 200 such that any time a change in display data is detected by display message origination system 100, the data can be updated on display 10. An example can include using display 10 as a traffic conditions display. Display 10 can be placed near a roadway where it is desirable to communicate traffic conditions to drivers passing by on the roadway. Display 10 can be connected to network 200 at that location. Display message origination system 100 can be placed in a central traffic monitoring location, such as an office building where traffic reports are sent. Changes in traffic conditions can be entered into display message origination system 100 either automatically or through manual input and communicated through network 200 to display 10 for communication to drivers.

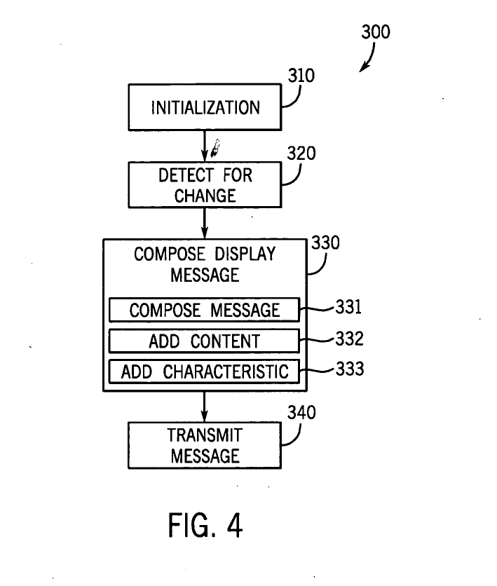

Referring to FIG. 4, a method 300 for automatically updating a remote display based on a change in the content of a spreadsheet cell is illustrated according to an exemplary embodiment. Method 300 can be implemented by processor 120 of display message origination system 100. It is understood that additional or fewer steps may be performed and one or more of the steps in this exemplary embodiment may be eliminated or rearranged.

In a step 310, spreadsheet application 150 containing an add-on function for automatically transferring display data from spreadsheet 155 to display 10 based on detection of a change in the display data for a cell in table 160 is initialized. Initialization can include transmitting the current contents of spreadsheet 155 to display 10 when spreadsheet application 150 is first started. Initialization can also include designation of display cells with spreadsheet 155 whose contents are to be displayed on display 10.

Initialization can further include configuring spreadsheet 155 or the add-on function to communicate with display 10. Configuration can include determine the size of the display area, color types available for display 10, display limitations, communication protocols, etc.

Following initialization, processor 120 enters a waiting mode in a step 320. During waiting mode, processor 120 monitors the contents of the display cells to determine whether any change has occurred to the contents of the cell. Changes can include changes to the data stored in the cell or changes to characteristics associated with the data in the cell. Changes can occur automatically or based on input from a user.

When a change is detected, a step 330 is performed where the detected change is communicated to display 10. Step 330 further includes composing a message configured to contain display data for communicating to display 10 in a step 331, populating the message with a display message retrieved from the designated cell where a change was detected in a step 332, and populating the message with at least one characteristic associated with the designated cell where a change was detected in a step 333.

Following composition of the display data in step 330, the display data is transmitted to display 10 in a step 340. Transmitting the display data can include transmission through a direct cable connection, through a hard-wired network, through a wireless network, etc.

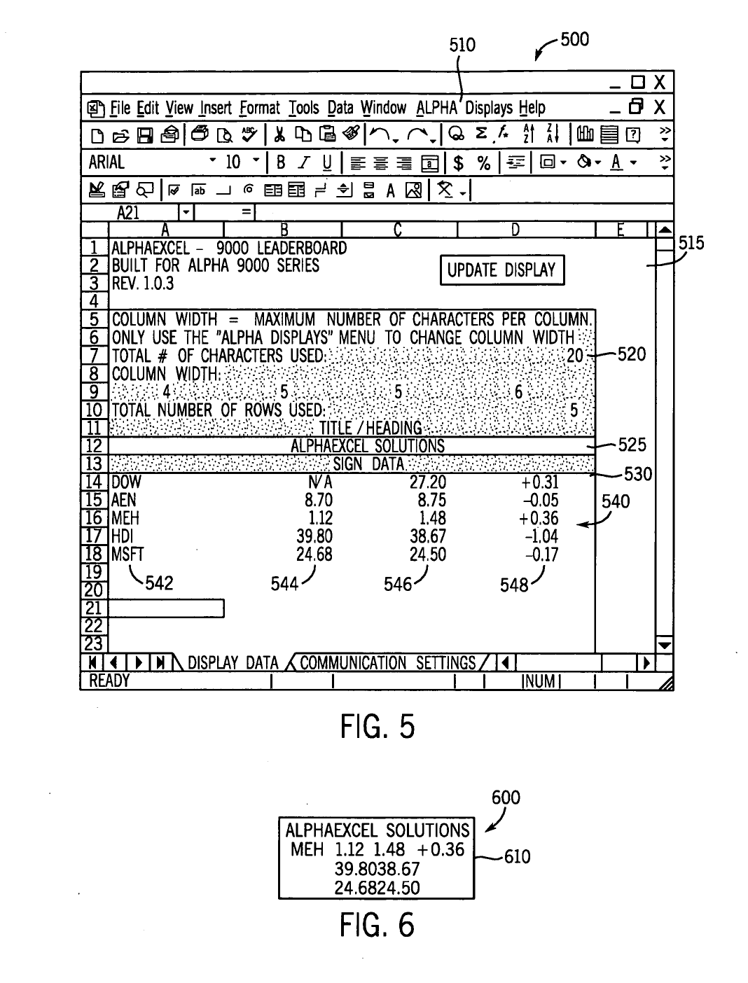

Referring now to FIG. 5, a spreadsheet application 500 is illustrated according to an exemplary embodiment. Spreadsheet application 500 includes a drop-down menu 510 entitled “ALPHA Displays”. Menu 510 is a menu that allows the user to select functions associated with the add-on function described above with reference to FIG. 2. For example, in operation, a number of spreadsheet templates can be packaged with spreadsheet application 500. A user can utilize drop-down menu 510 to select a spreadsheet template to open a spreadsheet that is to be populated with data to be displayed on display 10. The user can select a template based on the template's characteristics and their current needs. For example, one spreadsheet template may be configured to open a spreadsheet containing a table having 4 rows and 4 columns, another may open a spreadsheet having the same table, but including different formatting, yet another may open a spreadsheet having a different table and also including a function associated with the table. The spreadsheet templates can be configured to open any number and variety of spreadsheets configured to work with displays 10.

Additionally, a user can custom create a spreadsheet to meet their needs. Alternatively, any existing spreadsheet can be displayed on display 10 using the functions in drop down menu 510. For example, a user may wish to take an existing spreadsheet containing production statistics and display it on a display 10. The user may use the functions in drop-down menu 510 to define an area to be displayed and also define how the data should be displayed.

Drop-down menu 510 includes a list of functions that can be performed by the add-on function. These functions can include at least automatically updating a remote display based on a change to data stored in a cell in a spreadsheet.

An exemplary function can be a scrolling function. The scrolling function can be initiated by selecting “Scrolling” from drop-down menu 510. The scrolling function allows the user to provide more information in table 530 than can be displayed on the display 10 according to limitations in display 10, limitations based on font size, etc. For example, a table can include a number of rows that is greater than the number of rows that can be displayed on display 10. The scrolling function will control display 10 to list as many rows as can be displayed and periodically update the display to remove an older row and display a new row.

FIG. 5 illustrates an exemplary “Leaderboard” spreadsheet 515 according to an exemplary embodiment. Leaderboard spreadsheet 515 includes an information header 520, a title input field 525, a “leaderboard” table 530, and a plurality of cells 540 containing data for display on display 10. Information header 520 can include information related to the spreadsheet that helps a user understand how to use the spreadsheet. Title input field 525 can be a data field configured to receive a title for display at the top of the display area 40 of display 10. Leaderboard table 530 can be a table configured based on display 10 and the user's display needs. Leaderboard table 530 may also have functions associated with the table, such as a scrolling function as described above. These function may be provided by the add-on function through drop-down menu 510, inherent within the spreadsheet application, provided by an external program, etc.

Leaderboard table 530 can be configured such that the data contained in the table will be the same as the data displayed on display 10 according to an exemplary embodiment. Display 10 displays the data using the same formatting, text color, text font, etc. as appears in table 530. Additionally, any changes to the data in table 530 can be automatically reflected on display 10.

Leaderboard table 530 contains plurality of cells 540 containing data for display. Each of plurality of cells 540 may have one or more characteristics associated with the cell. For example, as shown in FIG. 5 in information header 520, each cell can include a column width describing the number of characters that may be included in the column. Each cell may further have a color, a format, a justification, etc. associated with the cell. Advantageously, any changes to the data or characteristics associated with any cell can instantly be reflected in display 10.

According to yet another exemplary embodiment, as shown in FIG. 5, plurality of cells 540 in leaderboard table 530 contain stock ticker names in a first column 542, opening prices in a second column 544, current prices in a third column 546, and price changes in a fourth column 548. According to an exemplary embodiment, the data stored in the cells in second column 544 and third column 546 can be updated from an external source. For example, the data in the cells in second column 544 and third column 546 using an Internet connection to a data source providing stock information. According to an exemplary embodiment, an opening price and a current price can be downloaded from the data source based on the stock ticker name provided in first column 542. The downloaded opening price and current price can be stored in the cells in second column 544 and third column 546. The data in the cells in fourth column 548 can be calculated based on the data in the cells in second column 544 and third column 546.

Referring now to FIG. 6, a display area 600 is shown displaying the contents of leaderboard table 530. According to an exemplary embodiment, leaderboard table 530 includes a scrolling function. Accordingly, table 530 includes more rows than are displayed in display area 40. Periodically a top row 610 in display area 600 will be deleted, successive rows will be moved up, and a next row from table 530 can be inserted. The scrolling function can be implemented such that this process will be repeated to cycle through all the rows in table 530.

While the exemplary embodiments illustrated in the figures and described above are presently preferred, it should be understood that these embodiments are offered by way of example only. Other embodiments may include, for example, differing communication protocols, networks used for communication, types of remote displays, etc. Further, while exemplary embodiments describe the invention in this context use the Microsoft® Excel™ spreadsheet application, the invention may extend to other types of spreadsheet applications. The invention is not limited to a particular embodiment, but extends to various modifications, combinations, and permutations that nevertheless fall within the scope and spirit of the appended claims.

1. A system for synchronizing data in a spreadsheet application with data on a remote display, the system comprising:
at least one data cell in the spreadsheet application, the data cell containing data to be displayed on the remote display and at least one characteristic associated with the data; and
an add-on function associated with the spreadsheet configured to detect changes to the data or the at least one characteristic, and to transmit a message to update the remote display based on detection of a change in the data or the at least one characteristic.

2. The system of claim 1, wherein the remote display is a light emitting diode (LED) display.

3. The system of claim 1, wherein the add-on function is configured to communicate with the remote display through a network.

4. The system of claim 1, wherein the add-on function is composed of a plurality of macros for the spreadsheet.

5. The system of claim 1, wherein detecting changes to the data includes configuring a macro to detect a change in the contents of the cell.

6. The system of claim 1, wherein the at least one characteristic includes a formatting for the data within a cell.

7. The system of claim 1, wherein the message is includes the contents of a cell in the spreadsheet and at least one characteristic related to the cell.

8. The system of claim 7, wherein at least one characteristic includes formatting for. the data within a cell.

9. The system of claim 1, wherein data in at least one cell for the spreadsheet is updated automatically from an external source.

10. The system of claim 1, wherein transmitting a message includes transmitting a message via the Internet.

11. A method for synchronizing the content of cells in a spreadsheet with a remote display displaying the content of the cells, the method comprising:
detecting a change in the contents of a cell in the spreadsheet;
determining the-content of the cell that was changed;
determining at least one characteristic for the cell that was changed; and
transmitting a message to the remote display to update the display based on the detected change.

12. The method of claim 11, further including configuring the spreadsheet to communicate with the remote display.

13. The method of claim 11, wherein detecting a change in the contents of a cell includes configuring a macro associated with the spreadsheet to detect a change in the contents of the cell.

14. The method of claim 11, wherein the at least one characteristic includes a formatting for the data within the cell that was changed.

15. The method of claim 11, wherein the message includes the contents of a cell in the spreadsheet and at least one characteristic related to the cell.

16. The method of claim 15, wherein the at least one characteristic includes formatting for the data within a cell.

17. The method of claim 11, wherein data in at least one cell for the spreadsheet is updated automatically from an external source.

18. The method of claim 11, wherein transmitting a message includes transmitting a message via the Internet.

19. A system for displaying information on a remote display, the system comprising:
a remote display configured to display information;
a data connection configured to transmit information to the remote display; and
a computer including a spreadsheet application, the spreadsheet application including an add on function configured to detect changes to the contents of a spreadsheet, the computer configured to transmit information to the remote display based on the detection of changes to the contents of a spreadsheet.

20. The system of claim 19, wherein the add-on function is implemented using macros within the spreadsheet application.
